(19) United States
(12) Patent Application Publication
(10) Pub. No.: US 2020/0178285 A1
(43) Pub. Date: Jun. 4, 2020

(54) ACKNOWLEDGEMENT INFORMATION TRANSMISSION METHOD, TERMINAL DEVICE, AND NETWORK DEVICE

(71) Applicant: HUAWEI TECHNOLOGIES CO., LTD., Shenzhen (CN)

(72) Inventors: Hao Sun, Beijing (CN); Bingyu Qu, Beijing (CN); Ruiqi Zhang, Beijing (CN)

(21) Appl. No.: 16/786,968

(22) Filed: Feb. 10, 2020

Related U.S. Application Data
(63) Continuation of application No. PCT/CN2018/095584, filed on Jul. 13, 2018.

(30) Foreign Application Priority Data
Aug. 11, 2017 (CN) 201710686094.6

(51) Int. Cl. H04W 72/12; H04L 1/18; H04L 5/00

(52) U.S. Cl. CPC H04W 72/1284; H04L 5/0055; H04L 1/1812

(57) ABSTRACT

In various embodiments, uplink scheduling information can be received by a terminal from a network device in a time cell n. The uplink scheduling information can be used to obtain a maximum quantity of first downlink data packets sent by the network device to the terminal device from a time cell n−k3 to a time cell n+k2. Acknowledgement information of the first downlink data packet can be sent by the terminal to the network device on a physical uplink shared channel in a time cell n+k1 based on the maximum quantity of the first downlink data packets. In this way, when the acknowledgement information is sent on the PUSCH, a data reception error caused by a case in which the base station does not know, when decoding the data, a quantity of pieces of acknowledgement information actually sent by the terminal is avoided.

### CROSS-REFERENCE TO RELATED APPLICATIONS

This application is a continuation of International Application No. PCT/CN2018/095584, filed on Jul. 13, 2018, which claims priority to Chinese Patent Application No. 201710686094.6, filed on Aug. 11, 2017. The disclosures of the aforementioned applications are hereby incorporated by reference in their entireties.

### TECHNICAL FIELD

Embodiments relate to communications systems, and in particular, to an acknowledgement information transmission method, a terminal device, and a network device.

### BACKGROUND

In a long term evolution (Long Term Evolution, LTE) system or a 5th generation (The 5th Generation, 5G) mobile communications system, a base station sends data to a terminal device on a physical downlink shared channel (PDSCH). The terminal device receives the data and feeds back an acknowledgement (ACK) or a negative acknowledgment (NACK) to the base station by using uplink control information (UCI). The ACK/NACK is used to notify the base station of whether the terminal device successfully or correctly receives the data. If the base station receives the NACK, the base station may send the data to the terminal device again.

Considering a single-carrier feature of uplink transmission and a problem of intermodulation distortion (IMD), the LTE system or the 5G system supports transmission of the UCI on a physical uplink shared channel (PUSCH) (UCI on PUSCH). When the UCI is transmitted on the PUSCH, a terminal transmits the UCI and uplink data by performing rate matching, in other words, after being jointly coded, the UCI and the uplink data are sent to the base station. Therefore, the base station and the terminal need to reach consensus on a quantity of pieces of UCI sent by the terminal to the base station on the PUSCH, to avoid an error occurred when the base station decodes the uplink data. The UCI includes ACK/NACK information.

The base station may send an uplink scheduling grant (UL Grant) to the terminal device, to schedule the terminal device to send the uplink data to the base station. In the UL grant, the base station notifies the terminal device of a quantity of downlink data packets that are sent by the base station. The base station and the terminal device reach consensus on the quantity of the sent downlink data packets, and the terminal sends ACK/NACK information to the base station based on the quantity of the sent downlink data packets.

In a 5G or future communications system, a base station sends a downlink data packet to a terminal device in a more flexible manner. For example, after the UL grant, the base station may further send a downlink data packet to the terminal device. An existing acknowledgement information transmission method is not flexible enough. In the UL grant, the base station fails to notify the terminal device of a quantity of downlink data packets sent by the base station to the terminal after the UL grant. As a result, the base station and the terminal device fail to reach consensus on the quantity of downlink data packets sent by the base station, an existing acknowledgement information feedback method fails to adapt to a problem, caused by flexible data sending, that the base station and the terminal do not reach consensus on a quantity of pieces of acknowledgement information, thereby causing an error when the base station decodes uplink data.

### SUMMARY

Embodiments provide an acknowledgement information transmission method, a terminal device, and a network device, to avoid an error occurred when a base station decodes uplink data.

According to a first aspect, an acknowledgement information sending method is provided. The method includes: receiving, by a terminal device, uplink scheduling information from a network device in a time cell n, where the uplink scheduling information is used to schedule a physical uplink shared channel of a time cell n+k1, the uplink scheduling information is further used to obtain a maximum quantity of first downlink data packets sent by the network device to the terminal device from a time cell n−k3 to a time cell n+k2, where n is a non-negative integer, k1, k2, and k3 are all positive integers, and k2<k1 or k2=k1; and sending, by the terminal device, acknowledgement information of the first downlink data packet to the network device on the physical uplink shared channel of the time cell n+k1 based on the maximum quantity of the first downlink data packets.

In this embodiment, a base station receives the acknowledgement information of the first downlink data packet from the terminal on the PUSCH of the time cell n+k1 based on the maximum quantity of the first downlink data packets. The terminal sends the acknowledgement information of the first downlink data packet to the base station on the PUSCH of the time cell n+k1 based on the maximum quantity of the first downlink data packets. The base station and the terminal reach consensus on a quantity of pieces of acknowledgement information fed back by the terminal to the base station on the PUSCH of the time cell n+k1. Therefore, when the acknowledgement information is sent on the PUSCH, a data reception error caused by a case in which the base station does not know, when decoding the data, a quantity of pieces of acknowledgement information actually sent by the terminal is avoided.

In one embodiment, the first downlink data packets include a second downlink data packet sent by the network device to the terminal device from the time cell n−k3 to a time cell n and a third downlink data packet allowed to be sent by the network device to the terminal device from the time cell n+1 to the time cell n+k2, where the uplink scheduling information includes first indication information and second indication information, the first indication information is used to indicate a quantity of the second downlink data packets, and the second indication information is used to indicate a maximum quantity of the third downlink data packets; or the uplink scheduling information includes first indication information, the first indication information is used to indicate a quantity of the second downlink data packets, and a maximum quantity of the third downlink data packets is predefined or configured by using higher layer signaling of the network device; or the uplink scheduling information includes first indication information, the first indication information is used to indicate a quantity Q2 of the second downlink data packets, and the maximum quantity of the first downlink data packets is min(k2′, (Q3−Q2))+Q2, where k2′ is a quantity of time cells allowed to transmit a downlink data packet from the time cell n+1 to the time cell n+k2, Q3 is a maximum quantity of hybrid automatic repeat request processes that is supported by the terminal device, Q2 is a non-negative integer, and Q3 is a positive integer. In this embodiment, the base station and the terminal may reach consensus on a quantity of pieces of acknowledgement information of a downlink data packet.

In one embodiment, the uplink scheduling information includes third indication information, and the third indication information is used to indicate the maximum quantity of the first downlink data packets. In this embodiment, the base station and the terminal may reach consensus on the quantity of pieces of acknowledgement information of the downlink data packet.

In one embodiment, the first indication information, the second indication information, or the third indication information includes a downlink assignment indicator DAI.

In one embodiment, the maximum quantity of the first downlink data packets is Q1, the acknowledgement information includes Q1 groups of acknowledgement information, and Q1 is a positive integer.

In one embodiment, k2 is predefined, or k2 is indicated by the uplink scheduling information, or k2 is configured by using the higher layer signaling of the network device, or k2 is determined based on a minimum hybrid automatic repeat request feedback timing capability supported by the terminal device.

In one embodiment, k3 is predefined, or k3 is indicated by the uplink scheduling information, or k3 is configured by using the higher layer signaling of the network device, or k3 is determined based on the maximum quantity of hybrid automatic repeat request processes that is supported by the terminal device.

In one embodiment, k2′+k3′≤Q3, and k3′ is a quantity of time cells allowed to transmit a downlink data packet from the time cell n−k3 to the time cell n.

In one embodiment, the minimum hybrid automatic repeat request feedback timing capability supported by the terminal device is a shortest time period t from a time point at which the terminal device receives the downlink data packet to a time point at which the terminal device sends the acknowledgement information of the first downlink data packet, and t is a minimum value of (k1−k2). In this embodiment, a time point at which the acknowledgement information is generated may be flexibly set based on minimum hybrid automatic repeat request feedback timing capabilities of different terminals.

In one embodiment, the terminal device begins to generate the acknowledgement information of the first downlink data packet in the time cell n+k2.

In one embodiment, acknowledgement information of the third downlink data packet is generated in a unit of a transport block TB. In this embodiment, signaling overheads for sending the acknowledgement information by the terminal can be reduced.

In one embodiment, the third downlink data packet is received by the terminal device from the network device in a plurality of carriers, and acknowledgement information of the third downlink data packet in the plurality of carriers is combined to generate the acknowledgement information of the third downlink data packet in a logic AND manner. In this embodiment, signaling overheads for sending the acknowledgement information by the terminal can be reduced.

In one embodiment, the third downlink data packet includes a plurality of codewords, and acknowledgement information of the plurality of codewords is combined to generate the acknowledgement information of the third downlink data packet in the logic AND manner. In this embodiment, signaling overheads for sending the acknowledgement information by the terminal can be reduced.

According to a second aspect, a terminal device is provided. The terminal device includes: a receiving unit, configured to receive uplink scheduling information from a network device in a time cell n, where the uplink scheduling information is used to schedule a physical uplink shared channel of a time cell n+k1, the uplink scheduling information is further used to obtain a maximum quantity of first downlink data packets sent by the network device to the terminal device from a time cell n−k3 to a time cell n+k2, where n is a non-negative integer, k1, k2, and k3 are all positive integers, and k2<k1 or k2=k1; and a sending unit, configured to send acknowledgement information of the first downlink data packet to the network device on the physical uplink shared channel of the time cell n+k1 based on the maximum quantity of the first downlink data packets.

In this embodiment, the base station receives the acknowledgement information of the first downlink data packet from the terminal on the PUSCH of the time cell n+k1 based on the maximum quantity of the first downlink data packets. The terminal sends the acknowledgement information of the first downlink data packet to the base station on the PUSCH of the time cell n+k1 based on the maximum quantity of the first downlink data packets. The base station and the terminal reach consensus on a quantity of pieces of acknowledgement information fed back by the terminal to the base station on the PUSCH of the time cell n+k1. Therefore, when the acknowledgement information is sent on the PUSCH, a data reception error caused by a case in which the base station does not know, when decoding the data, a quantity of pieces of acknowledgement information actually sent by the terminal is avoided.

In one embodiment, the first downlink data packets include a second downlink data packet sent by the network device to the terminal device from the time cell n−k3 to a time cell n and a third downlink data packet allowed to be sent by the network device to the terminal device from the time cell n+1 to the time cell n+k2, where the uplink scheduling information includes first indication information and second indication information, the first indication information is used to indicate a quantity of the second downlink data packets, and the second indication information is used to indicate a maximum quantity of the third downlink data packets; or the uplink scheduling information includes first indication information, the first indication information is used to indicate a quantity of the second downlink data packets, and a maximum quantity of the third downlink data packets is predefined or configured by using higher layer signaling of the network device; or the uplink scheduling information includes first indication information, the first indication information is used to indicate a quantity Q2 of the second downlink data packets, and the maximum quantity of the first downlink data packets is min(k2′, (Q3−Q2))+Q2, where k2′ is a quantity of time cells allowed to transmit a downlink data packet from the time cell n+1 to the time cell n+k2, Q3 is a maximum quantity of hybrid automatic repeat request processes that is supported by the terminal device, Q2 is a non-negative integer, and Q3 is a positive integer. In this embodiment, the base station and the terminal may reach consensus on a quantity of pieces of acknowledgement information of a downlink data packet.

In one embodiment, the uplink scheduling information includes third indication information, and the third indication information is used to indicate the maximum quantity of the first downlink data packets. In this embodiment, the base station and the terminal may reach consensus on the quantity of pieces of acknowledgement information of the downlink data packet.

In one embodiment, the first indication information, the second indication information, or the third indication information includes a downlink assignment indicator DAI.

In one embodiment, the maximum quantity of the first downlink data packets is Q1, the acknowledgement information includes Q1 groups of acknowledgement information, and Q1 is a positive integer.

In one embodiment, k2 is predefined, or k2 is indicated by the uplink scheduling information, or k2 is configured by using the higher layer signaling of the network device, or k2 is determined based on a minimum hybrid automatic repeat request feedback timing capability supported by the terminal device.

In one embodiment, k3 is predefined, or k3 is indicated by the uplink scheduling information, or k3 is configured by using the higher layer signaling of the network device, or k3 is determined based on the maximum quantity of hybrid automatic repeat request processes that is supported by the terminal device.

In one embodiment, k2′+k3′≤Q3, and k3′ is a quantity of time cells allowed to transmit a downlink data packet from the time cell n−k3 to the time cell n.

In one embodiment, the minimum hybrid automatic repeat request feedback timing capability supported by the terminal device is a shortest time period t from a time point at which the receiving unit receives the downlink data packet to a time point at which the sending unit sends the acknowledgement information of the first downlink data packet, and t is a minimum value of (k1−k2). In this embodiment, a time point at which the acknowledgement information is generated may be flexibly set based on minimum hybrid automatic repeat request feedback timing capabilities of different terminals.

In one embodiment, a generation unit is configured to begin to generate the acknowledgement information of the first downlink data packet in the time cell n+k2.

In one embodiment, acknowledgement information of the third downlink data packet is generated in a unit of a transport block TB. In this embodiment, signaling overheads for sending the acknowledgement information by the terminal can be reduced.

In one embodiment, the third downlink data packet is received by the receiving unit from the network device in a plurality of carriers, and acknowledgement information of the third downlink data packet in the plurality of carriers is combined by the generation unit to generate the acknowledgement information of the third downlink data packet in a logic AND manner. In this embodiment, signaling overheads for sending the acknowledgement information by the terminal can be reduced.

In one embodiment, the third downlink data packet includes a plurality of codewords, and acknowledgement information of the plurality of codewords is combined by the generation unit to generate the acknowledgement information of the third downlink data packet in the logic AND manner. In this embodiment, signaling overheads for sending the acknowledgement information by the terminal can be reduced.

According to a third aspect, an acknowledgement information receiving method is provided. The method includes: sending, by a network device, uplink scheduling information to a terminal device in a time cell n, where the uplink scheduling information is used to schedule a physical uplink shared channel of a time cell n+k1, the uplink scheduling information is further used to obtain a maximum quantity of first downlink data packets sent by the network device to the terminal device from a time cell n−k3 to a time cell n+k2, where n is a non-negative integer, k1, k2, and k3 are all positive integers, and k2<k1 or k2=k1; and receiving, by the network device, acknowledgement information of the first downlink data packet from the terminal device on the physical uplink shared channel of the time cell n+k1 based on the maximum quantity of the first downlink data packets.

In this embodiment, the base station receives the acknowledgement information of the first downlink data packet from the terminal on the PUSCH of the time cell n+k1 based on the maximum quantity of the first downlink data packets. The terminal sends the acknowledgement information of the first downlink data packet to the base station on the PUSCH of the time cell n+k1 based on the maximum quantity of the first downlink data packets. The base station and the terminal reach consensus on a quantity of pieces of acknowledgement information fed back by the terminal to the base station on the PUSCH of the time cell n+k1. Therefore, when the acknowledgement information is sent on the PUSCH, a data reception error caused by a case in which the base station does not know, when decoding the data, a quantity of pieces of acknowledgement information actually sent by the terminal is avoided.

In one embodiment, the first downlink data packets include a second downlink data packet sent by the network device to the terminal device from the time cell n−k3 to a time cell n and a third downlink data packet allowed to be sent by the network device to the terminal device from the time cell n+1 to the time cell n+k2, where the uplink scheduling information includes first indication information and second indication information, the first indication information is used to indicate a quantity of the second downlink data packets, and the second indication information is used to indicate a maximum quantity of the third downlink data packets; or the uplink scheduling information includes first indication information, the first indication information is used to indicate a quantity of the second downlink data packets, and a maximum quantity of the third downlink data packets is predefined or configured by using higher layer signaling of the network device; or the uplink scheduling information includes first indication information, the first indication information is used to indicate a quantity Q2 of the second downlink data packets, and the maximum quantity of the first downlink data packets is min(k2′, (Q3−Q2))+Q2, where k2′ is a quantity of time cells allowed to transmit a downlink data packet from the time cell n+1 to the time cell n+k2, Q3 is a maximum quantity of hybrid automatic repeat request processes that is supported by the terminal device, Q2 is a non-negative integer, and Q3 is a positive integer. In this embodiment, the base station and the terminal may reach consensus on a quantity of pieces of acknowledgement information of the downlink data packet.

In one embodiment, the uplink scheduling information includes third indication information, and the third indication information is used to indicate the maximum quantity of the first downlink data packets. In this embodiment, the base station and the terminal may reach consensus on a quantity of pieces of acknowledgement information of the downlink data packet.

In one embodiment, the first indication information, the second indication information, or the third indication information includes a downlink assignment indicator DAI.

In one embodiment, the maximum quantity of the first downlink data packets is Q1, the acknowledgement information includes Q1 groups of acknowledgement information, and Q1 is a positive integer

In one embodiment, k2 is predefined, or k2 is indicated by the uplink scheduling information, or k2 is configured by using the higher layer signaling of the network device, or k2 is determined based on a minimum hybrid automatic repeat request feedback timing capability supported by the terminal device.

In one embodiment, k3 is predefined, or k3 is indicated by the uplink scheduling information, or k3 is configured by using the higher layer signaling of the network device, or k3 is determined based on the maximum quantity of hybrid automatic repeat request processes that is supported by the terminal device.

In one embodiment, k2′+k3′≤Q3, and k3′ is a quantity of time cells allowed to transmit a downlink data packet from the time cell n−k3 to the time cell n.

In one embodiment, the minimum hybrid automatic repeat request feedback timing capability supported by the terminal device is a shortest time period t from a time point at which the terminal device receives the downlink data packet to a time point at which the terminal device sends the acknowledgement information of the first downlink data packet, and t is a minimum value of (k1−k2). In this embodiment, a time point at which the acknowledgement information is generated may be flexibly set based on minimum hybrid automatic repeat request feedback timing capabilities of different terminals.

In one embodiment, acknowledgement information of the third downlink data packet is generated in a unit of a transport block TB. In this embodiment, signaling overheads for sending the acknowledgement information by the terminal can be reduced.

In one embodiment, the third downlink data packet is sent by the network device to the terminal device in a plurality of carriers, and acknowledgement information of the third downlink data packet in the plurality of carriers is combined to generate the acknowledgement information of the third downlink data packet in a logic AND manner. In this embodiment, signaling overheads for sending the acknowledgement information by the terminal can be reduced.

In one embodiment, the third downlink data packet includes a plurality of codewords, and acknowledgement information of the plurality of codewords is combined to generate the acknowledgement information of the third downlink data packet in the logic AND manner. In this embodiment, signaling overheads for sending the acknowledgement information by the terminal can be reduced.

According to a fourth aspect, a network device is provided. The network device includes: a sending unit, configured to send uplink scheduling information to a terminal device in a time cell n, where the uplink scheduling information is used to schedule a physical uplink shared channel of a time cell n+k1, the uplink scheduling information is further used to obtain a maximum quantity of first downlink data packets sent by the sending unit to the terminal device from a time cell n−k3 to a time cell n+k2, where n is a non-negative integer, k1, k2, and k3 are all positive integers, and k2<k1 or k2=k1; and a receiving unit, configured to receive acknowledgement information of the first downlink data packet from the terminal device on the physical uplink shared channel of the time cell n+k1 based on the maximum quantity of the first downlink data packets.

In this embodiment, the base station receives the acknowledgement information of the first downlink data packet from the terminal on the PUSCH of the time cell n+k1 based on the maximum quantity of the first downlink data packets. The terminal sends the acknowledgement information of the first downlink data packet to the base station on the PUSCH of the time cell n+k1 based on the maximum quantity of the first downlink data packets. The base station and the terminal reach consensus on a quantity of pieces of acknowledgement information fed back by the terminal to the base station on the PUSCH of the time cell n+k1. Therefore, when the acknowledgement information is sent on the PUSCH, a data reception error caused by a case in which the base station does not know, when decoding the data, a quantity of pieces of acknowledgement information actually sent by the terminal is avoided.

In one embodiment, the first downlink data packets include a second downlink data packet sent by the sending unit to the terminal device from the time cell n−k3 to a time cell n and a third downlink data packet allowed to be sent by the sending unit to the terminal device from the time cell n+1 to the time cell n+k2, where the uplink scheduling information includes first indication information and second indication information, the first indication information is used to indicate a quantity of the second downlink data packets, and the second indication information is used to indicate a maximum quantity of the third downlink data packets; or the uplink scheduling information includes first indication information, the first indication information is used to indicate a quantity of the second downlink data packets, and a maximum quantity of the third downlink data packets is predefined or configured by using higher layer signaling of the network device; or the uplink scheduling information includes first indication information, the first indication information is used to indicate a quantity Q2 of the second downlink data packets, and the maximum quantity of the first downlink data packets is min(k2′, (Q3−Q2))+Q2, where k2′ is a quantity of time cells allowed to transmit a downlink data packet from the time cell n+1 to the time cell n+k2, Q3 is a maximum quantity of hybrid automatic repeat request processes that is supported by the terminal device, Q2 is a non-negative integer, and Q3 is a positive integer. In this embodiment, the base station and the terminal may reach consensus on a quantity of pieces of acknowledgement information of a downlink data packet.

In one embodiment, the uplink scheduling information includes third indication information, and the third indication information is used to indicate the maximum quantity of the first downlink data packets. In this embodiment, the base station and the terminal may reach consensus on the quantity of pieces of acknowledgement information of the downlink data packet.

In one embodiment, the first indication information, the second indication information, or the third indication information includes a downlink assignment indicator DAI.

In one embodiment, the maximum quantity of the first downlink data packets is Q1, the acknowledgement information includes Q1 groups of acknowledgement information, and Q1 is a positive integer.

In one embodiment, k2 is predefined, or k2 is indicated by the uplink scheduling information, or k2 is configured by using the higher layer signaling of the network device, or k2 is determined based on a minimum hybrid automatic repeat request feedback timing capability supported by the terminal device.

In one embodiment, k3 is predefined, or k3 is indicated by the uplink scheduling information, or k3 is configured by using the higher layer signaling of the network device, or k3 is determined based on the maximum quantity of hybrid automatic repeat request processes that is supported by the terminal device.

In one embodiment, k2′+k3′≤Q3, and k3′ is a quantity of time cells allowed to transmit a downlink data packet from the time cell n−k3 to the time cell n.

In one embodiment, the minimum hybrid automatic repeat request feedback timing capability supported by the terminal device is a shortest time period t from a time point at which the terminal device receives the downlink data packet to a time point at which the terminal device sends the acknowledgement information of the first downlink data packet, and t is a minimum value of (k1−k2). In this embodiment, a time point at which the acknowledgement information is generated may be flexibly set based on minimum hybrid automatic repeat request feedback timing capabilities of different terminals.

In one embodiment, acknowledgement information of the third downlink data packet is generated in a unit of a transport block TB. In this embodiment, signaling overheads for sending the acknowledgement information by the terminal can be reduced.

In one embodiment, the third downlink data packet is sent by the sending unit to the terminal device in a plurality of carriers, and acknowledgement information of the third downlink data packet in the plurality of carriers is combined to generate the acknowledgement information of the third downlink data packet in a logic AND manner. In this embodiment, signaling overheads for sending the acknowledgement information by the terminal can be reduced.

In one embodiment, the third downlink data packet includes a plurality of codewords, and acknowledgement information of the plurality of codewords is combined to generate the acknowledgement information of the third downlink data packet in the logic AND manner. In this embodiment, signaling overheads for sending the acknowledgement information by the terminal can be reduced.

According to a fifth aspect, an embodiment provides a computer storage medium, configured to store computer software instructions used by the foregoing network device, where the computer software instructions include a program designed for performing the foregoing aspects.

According to a sixth aspect, an embodiment provides a computer storage medium, configured to store computer software instructions used by the foregoing terminal device, where the computer software instructions include a program designed for performing the foregoing aspects.

According to a seventh aspect, an embodiment provides a computer program product. The program product stores computer software instructions used by the foregoing access network device or the foregoing terminal device, and the computer software instructions include a program used to execute the solutions in the foregoing aspects.

According to an eighth aspect, an embodiment provides a chip, configured to perform the methods in the foregoing aspects. The chip may have a part of functions of a memory, a processor, a transmitter, a receiver, and/or a transceiver, and the memory stores an instruction, code, and/or data, to perform the methods in the foregoing aspects.

According to a ninth aspect, an embodiment provides a system. The system includes the network device and the terminal device in the foregoing aspects.

### BRIEF DESCRIPTION OF DRAWINGS

FIG. 1 is a schematic architectural diagram of a system according to an embodiment;

FIG. 2 shows an acknowledgement information transmission method, a terminal, a base station, and a system according to an embodiment;

FIG. 3 shows a base station according to an embodiment; and

FIG. 4 shows a terminal according to an embodiment.

### DESCRIPTION OF EMBODIMENTS

In FIG. 1, a network device sends downlink data to a terminal device, and after the terminal device receives the downlink data, the terminal device may send ACK/NACK information and uplink data to a base station. The ACK/NACK information is used by the terminal device to feedback whether the downlink data sent by the network device is successfully or correctly received. If the network device receives the ACK information, the network device may continue to send other downlink data to the terminal device, and if the network device receives the NACK information, the base station may send the downlink data to the terminal device again, thereby improving reliability of data sending.

The network device in accordance with this disclosure is an apparatus that is deployed in a radio access network and that is configured to provide a wireless communication function for the terminal device. The network device may include various forms of base stations (BS), such as a macro base station, a micro base station, a relay node, and an access point. In systems that use different radio access technologies, a device with a network device function may have different names. For example, the network device is a network device in a 5th generation 5G network; in an LTE network, the network device is referred to as an evolved NodeB (eNB or eNodeB for short); and in a 3rd generation 3G network, the network device is referred to as a NodeB, or a road side unit (RSU) in V2V communication. For ease of description, in accordance with this disclosure, the foregoing apparatus that provides the wireless communication function for the terminal device is collectively referred to as the network device.

The terminal device in accordance with this disclosure may include various handheld devices having the wireless communication function, for example, vehicle-mounted devices, wearable devices, computing devices, or other processing devices connected to a wireless modem, mobile stations (MS), terminals, user equipment, and the like. For ease of description, in accordance with this disclosure, the devices mentioned above are collectively referred to as the terminal devices.

The following describes various embodiments in more detail with reference to a specific example in which the network device is a base station and the terminal device is a terminal.

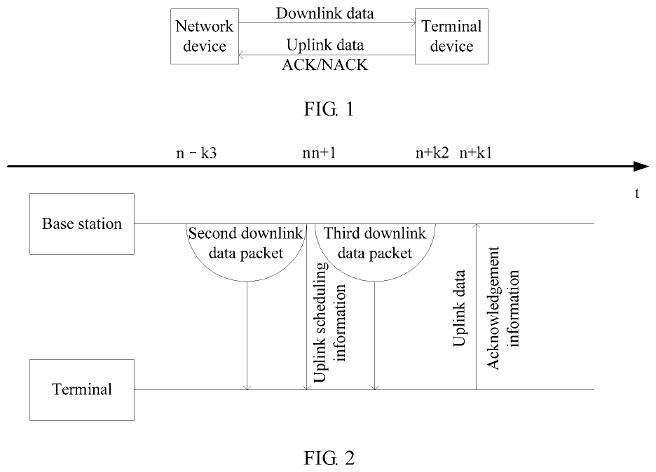

FIG. 2 shows an acknowledgement information transmission method, a terminal, a base station, and a system according to an embodiment. Specific steps are as follows.

Step 21. The base station sends a second downlink data packet to the terminal on a PDSCH from a time cell n−k3 to a time cell n, and the terminal receives the second downlink data packet from the base station on the PDSCH from the time cell n−k3 to the time cell n. The time cell includes a subframe, a slot, a mini slot, an orthogonal frequency division multiplexing (OFDM) multiple access symbol, a discrete Fourier transform spread orthogonal frequency division multiplexing (DFT-s-OFDM) symbol, or a time granularity of any length.

Step 22. The base station sends uplink scheduling information to the terminal in the time cell n. The uplink scheduling information is carried by downlink control signaling sent by the base station to the terminal. The downlink control signaling may be understood as an uplink scheduling grant (UL grant), and the terminal receives the uplink scheduling information from the base station in the time cell n. The uplink scheduling information is used to schedule a physical uplink shared channel sent by the terminal to the base station in a time cell n+k1.

The uplink scheduling information is further used to obtain a maximum quantity of first downlink data packets sent by the base station to the terminal from the time cell n−k3 to a time cell n+k2. The first downlink data packets include a second downlink data packet sent by the base station to the terminal from the time cell n−k3 to the time cell n and a third downlink data packet allowed to be sent by the base station to the terminal from the time cell n+1 to the time cell n+k2, and n is a non-negative integer. The non-negative integer is 0 or a positive integer, k1, k2, and k3 are all positive integers, and k2<k1 or k2=k1. Preferably, k2 is predefined, or k2 is indicated by the uplink scheduling information, or k2 is configured by using higher layer signaling of the network device, or k2 is determined based on a minimum hybrid automatic repeat request feedback timing capability supported by the terminal device; k3 is predefined, or k3 is indicated by the uplink scheduling information, or k3 is configured by using higher layer signaling of the network device, or k3 is determined based on a maximum quantity of hybrid automatic repeat request processes that is supported by the terminal device. The maximum quantity of the first downlink data packets is greater than a quantity of the second downlink data packets. The second downlink data packet is one or more downlink data packets.

The second downlink data packet is a data packet sent by the base station to the terminal from the time cell n−k3 to the time cell n. Therefore, the base station may obtain a specific quantity of the second downlink data packets in the time cell n. The third downlink data packet is a data packet sent by the base station to the terminal from the time cell n+1 to the time cell n+k2. A specific quantity of the third downlink data packets may be obtained in the time cell n in which the base station sends the uplink scheduling information, or may not be obtained.

When the base station may obtain, in the time cell n, the specific quantity of the third downlink data packets to be sent by the base station to the terminal from the time cell n+1 to the time cell n+k2, the base station may notify the terminal of the specific quantity of the second downlink data packets and the specific quantity of the third downlink data packets by using the uplink scheduling information, or may notify the terminal of a sum of the specific quantity of the second downlink data packets and the specific quantity of the third downlink data packets by using the uplink scheduling information.

When the base station fails to obtain, in the time cell n, the specific quantity of the third downlink data packets to be sent by the base station to the terminal from the time cell n+1 to the time cell n+k2, the base station fails to obtain, in the time cell n, a specific quantity of the third downlink data packets to be sent by the base station to the terminal behind the time cell n. In this case, the base station performs one of the following four operations.

First, the uplink scheduling information includes first indication information and second indication information, the first indication information is used to indicate a quantity of the second downlink data packets, and the second indication information is used to indicate a maximum quantity of the third downlink data packets. The base station fails to know the specific quantity of the third downlink data packets and fails to notify the terminal of the specific quantity of the third downlink data packets. Therefore, the base station may notify the terminal of the maximum quantity of the third downlink data packets by using the uplink scheduling information. In other words, no matter how many downlink data packets are sent by the base station to the terminal from the time cell n+1 to the time cell n+k2, the terminal feeds back, based only on the maximum quantity of the third downlink data packets, acknowledgement information of the downlink data packets received by the terminal from the time cell n+1 to the time cell n+k2. The terminal feeds back the acknowledgement information of the downlink data packets received by the terminal from the time cell n−k3 to the time cell n+k2 to the base station based on the quantity of the second downlink data packets and the maximum quantity of the third downlink data packets.

Second, the uplink scheduling information includes first indication information, the first indication information is used to indicate a quantity of the second downlink data packets, and a maximum quantity of the third downlink data packets is predefined or configured by using higher layer signaling of the base station.

The base station or the terminal fails to know the specific quantity of the third downlink data packets and fails to notify the terminal of the specific quantity of the third downlink data packets. However, the maximum quantity of the third downlink data packets may be predefined by a protocol, or the maximum quantity of the third downlink data packets may be configured by using the higher layer signaling of the base station. Therefore, the base station or the terminal may obtain the maximum quantity of the third downlink data packets sent by the base station to the terminal from the time cell n+1 to the time cell n+k2. In other words, no matter how many downlink data packets are sent by the base station to the terminal from the time cell n+1 to the time cell n+k2, the terminal feeds back, based only on the maximum quantity of the third downlink data packets, acknowledgement information of the downlink data packets received by the terminal from the time cell n+1 to the time cell n+k2. The terminal feeds back the acknowledgement information of the downlink data packets received by the terminal from the time cell n−k3 to the time cell n+k2 to the base station based on the quantity of the second downlink data packets and the maximum quantity of the third downlink data packets.

Third, the uplink scheduling information includes first indication information, the first indication information is used to indicate a quantity Q2 of the second downlink data packets, and the maximum quantity of the first downlink data packets is min(k2′, (Q3−Q2))+Q2. In other words, the base station or the terminal determines min(k2′, (Q3−Q2))+Q2 as the maximum quantity of the first downlink data packets, where k2′ is a quantity of time cells allowed to transmit a downlink data packet from the time cell n+1 to the time cell n+k2, in other words, k2′ is a quantity of remaining time cells different from a time cell that cannot be used to transmit a downlink data packet from the time cell n+1 to the time cell n+k2, and the time cell that cannot be used to transmit the downlink data packet may be, for example, an uplink subframe or a reserved subframe; and k2′+k3′≤Q3, k3′ is a quantity of time cells allowed to transmit a downlink data packet from the time cell n−k3 to the time cell n, in other words, k3′ is a quantity of remaining time cells different from a time cell that cannot be used to transmit a downlink data packet from the time cell n−k3 to the time cell n, the time cell that cannot be used to transmit the downlink data packet may be, for example, an uplink subframe or a reserved subframe, Q3 is the maximum quantity of hybrid automatic repeat request processes that is supported by the terminal device, and both Q2 and Q3 are positive integers. The base station or the terminal fails to know the specific quantity of the third downlink data packets and fails to notify the terminal of the specific quantity of the third downlink data packets. However, the base station notifies the terminal of the quantity of the second downlink data packets by using the uplink scheduling information, and the base station or the terminal determines a minimum value between k2′ and a value that is obtained by subtracting the quantity of the second downlink data packets from the maximum quantity of hybrid automatic repeat request processes that is supported by the terminal device, and uses a sum of the minimum value and the quantity of the second downlink data packets as the maximum quantity of the first downlink data packets. In other words, no matter how many downlink data packets are sent by the base station to the terminal from the time cell n−k3 to the time cell n+k2, the terminal feeds back, based only on the maximum quantity of the first downlink data packets, acknowledgement information of the downlink data packets received by the terminal from the base station from the time cell n−k3 to the time cell n+k2.

For example, the quantity Q2 of the second downlink data packets is 2, and the maximum quantity Q3 of hybrid automatic repeat request processes that is supported by the terminal is 6. In other words, the terminal can buffer only at most six downlink data packets. If there are seven time cells in total from the time cell n+1 to the time cell n+k2, but two of the time cells are uplink subframes that cannot be used to transmit the downlink data packet, k2′ is 5, and min(5, (6−2))=4. Therefore, the maximum quantity of the first downlink data packets is 4+2=6, in other words, the maximum quantity of the first downlink data packets is the maximum quantity Q3 of hybrid automatic repeat request processes that is supported by the terminal device. If there are seven time cells in total from the time cell n+1 to the time cell n+k2, but four of the time cells are uplink subframes that cannot be used to transmit the downlink data packet, k2′ is 3, and min(3, (6−2))=3. Therefore, the maximum quantity of the first downlink data packets is 3+2=5, in other words, although the terminal is still capable of continuing to buffer the downlink data packet, due to a limitation of k2, the terminal can store three downlink data packets as the third downlink data packet only after the base station sends the uplink scheduling information, where k2 is predefined, or k2 is indicated by the uplink scheduling information, or k2 is semi-statically configured by using the higher layer signaling of the network device, or k2 is determined based on the minimum hybrid automatic repeat request feedback timing capability supported by the terminal device. The minimum hybrid automatic repeat request feedback timing capability supported by the terminal device is a shortest time period t from a time point at which the terminal device receives the downlink data packet to a time point at which the terminal device sends acknowledgement information of the first downlink data packet, and t is a minimum value of (k1−k2), in other words, a minimum quantity of time cells required by the terminal to generate the acknowledgement information.

Fourth, the uplink scheduling information includes third indication information, and the third indication information is used to indicate the maximum quantity of the first downlink data packets. The base station fails to know the specific quantity of the third downlink data packets and fails to notify the terminal of the specific quantity of the third downlink data packets. However, the base station may notify the terminal of a maximum value of a sum of the quantity of the second downlink data packets and the quantity of the third downlink data packets by using the uplink scheduling information. In other words, no matter how many downlink data packets are sent by the base station to the terminal from the time cell n−k3 to the time cell n+k2, the terminal feeds back, based only on the maximum quantity of the first downlink data packets, acknowledgement information of the downlink data packets received by the terminal from the base station from the time cell n−k3 to the time cell n+k2.

The first indication information, the second indication information, or the third indication information includes a downlink assignment indicator (DAI), and the DAI is a part of fields in the UL grant.

In the first to the third manners, although the base station fails to know, in the time cell n, the specific quantity of the third downlink data packets to be sent by the base station to the terminal from the time cell n+1 to the time cell n+k2, the base station and the terminal may obtain the maximum quantity of the first downlink data packets by using an actual quantity of the second downlink data packets and a maximum quantity of the third downlink data packets. In the fourth manner, the base station directly indicates the maximum quantity of the first downlink data packets of the terminal by using the third indication information.

Step 23. The base station sends the third downlink data packet to the terminal on the PDSCH from the time cell n+1 to the time cell n+k2, and the terminal receives the third downlink data packet from the base station on the PDSCH from the time cell n+1 to the time cell n+k2. The quantity of the third downlink data packets may be 0 or a positive integer. Preferably, both the quantity of the second downlink data packets and the quantity of the third downlink data packets are positive integers. The third downlink data packet is one or more downlink data packets.

Step 24. The base station receives acknowledgement information of the first downlink data packet from the terminal on a physical uplink shared channel PUSCH of a time cell n+k1 based on the maximum quantity of the first downlink data packets, and the terminal sends the acknowledgement information of the downlink data packet to the base station on the physical uplink shared channel PUSCH of the time cell n+k1 based on the maximum quantity of the first downlink data packets. Optionally, the acknowledgement information may be specifically ACK information or NACK information.

After step 24, the base station and the terminal reach consensus on a quantity of pieces of the acknowledgement information fed back by the terminal to the base station on the PUSCH of the time cell n+k1. For example, both the base station and the terminal may know that the acknowledgement information fed back by the terminal to the base station on the PUSCH of the time cell n+k1 is x bits, and both the base station and the terminal may also know that uplink data sent by the terminal to the base station on the PUSCH of the time cell n+k1 is y bits. Rate matching is performed by the terminal. In other words, after performing channel encoding on the y bits of the uplink data and excluding physical resources occupied for transmitting the acknowledgement information and/or other UCI from all allocated physical resources, the terminal performs rate matching, and sends the UCI and other information by using the physical resources to the base station. The base station may also decode the received data information based on the x bits of the acknowledgement information and the y bits of the uplink data, to correctly obtain acknowledgement information of the uplink data and the acknowledgement information of the downlink data packet.

The terminal feeds back the acknowledgement information to the base station based on the maximum quantity of the first downlink data packets, instead of feeding back the acknowledgement information to the base station based on an actual quantity of downlink data packets sent by the base station to the terminal. The base station also receives the acknowledgement information from the terminal based on the maximum quantity of the first downlink data packets, instead of receiving the acknowledgement information from the terminal based on the actual quantity of downlink data packets sent by the base station to the terminal. For example, if the quantity of the second downlink data packets is 2, and the maximum quantity of the third downlink data packets is 4, the maximum quantity of the first downlink data packets is 2+4=6. However, the actual quantity of the third downlink data packets sent by the base station to the terminal is just 2, a sum of the quantity of the second downlink data packets and the quantity of the third downlink data packets that are actually sent by the base station to the terminal is 4. The maximum quantity of the third downlink data packets minus the actual quantity of the third downlink data packets is 2. Therefore, the terminal does not merely feed back acknowledgement information of the actually sent second downlink data packets and acknowledgement information of the actually sent third downlink data packets, the terminal may further feed back acknowledgement information corresponding to two reserved downlink data packets for a quantity 2 of downlink data packets that are reserved but not actually sent and that are obtained by subtracting the actual quantity of the third downlink data packets from the maximum quantity of the third downlink data packets.

For example, if one downlink data packet includes one transport block (Transport Block, TB), two NACKs are fed back, and if one downlink data packet includes two transport blocks TB, four NACKs are fed back.

The acknowledgement information is not generated by the terminal immediately. Instead, the generation of the acknowledgement information takes time.

A shortest time for the terminal to generate the acknowledgement information may be predefined by a protocol or configured by using higher layer signaling. In addition, a value of k2 may also be predefined by a protocol or configured by using higher layer signaling, and therefore the shortest time for the terminal to generate the acknowledgement information is t, and t is a minimum value of (k1−k2). The shortest time for the terminal to generate the acknowledgement information may alternatively be determined based on a minimum hybrid automatic repeat request feedback timing capability supported by the terminal. The minimum hybrid automatic repeat request feedback timing capability supported by the terminal is a shortest time period t from a time point at which the terminal receives the downlink data packet to a time point at which the terminal sends the acknowledgement information of the downlink data packet, and t is the minimum value of (k1−k2). Although the terminal sends the acknowledgement information of the downlink data packet to the base station on the PUSCH of the time cell n+k1, the terminal needs to begin to generate the acknowledgement information at a latest time cell n+k2. In this way, the acknowledgement information of the downlink data packet can be generated in the time cell n+k1 or before the time cell n+k1, so that the acknowledgement information of the downlink data packet can be sent to the base station in the time cell n+k1.

In step 24, if the maximum quantity of the first downlink data packets is Q1, the acknowledgement information includes Q1 groups of acknowledgement information, and Q1 is a positive integer. The acknowledgement information of the downlink data packet may be fed back in a unit of a code block group (CBG), and the acknowledgement information of the downlink data packet may alternatively be fed back in a unit of a transport block TB. If the base station configures the terminal to perform the feedback in a unit of a CBG from the time cell n−k3 to the time cell n+k2, a feedback of all data packets including data packets received in the time cell n+1 and the third downlink data packet is rolled back to a feedback performed by the terminal in a unit of a TB. In other words, the acknowledgement information of the third downlink data packet is generated in a unit of a transport block TB. Therefore, signaling overheads of the acknowledgement information can be reduced.

When the third downlink data packet is sent by the base station to the terminal in a plurality of carriers, acknowledgement information of the third downlink data packet in the plurality of carriers is combined to generate the acknowledgement information of the third downlink data packet in a logic AND manner. When the third downlink data packet includes a plurality of codewords, acknowledgement information of the plurality of codewords is combined to generate the acknowledgement information of the third downlink data packet in the logic AND manner. Therefore, signaling overheads of the acknowledgement information can be reduced.

In this embodiment, the base station receives the acknowledgement information of the first downlink data packet from the terminal on the PUSCH of the time cell n+k1 based on the maximum quantity of the first downlink data packets. The terminal sends the acknowledgement information of the first downlink data packet to the base station on the PUSCH of the time cell n+k1 based on the maximum quantity of the first downlink data packets. The base station and the terminal reach consensus on a quantity of pieces of acknowledgement information fed back by the terminal to the base station on the PUSCH of the time cell n+k1. Therefore, when the acknowledgement information is sent on the PUSCH, a data reception error caused by a case in which the base station does not know, when decoding the data, a quantity of pieces of acknowledgement information actually sent by the terminal is avoided.

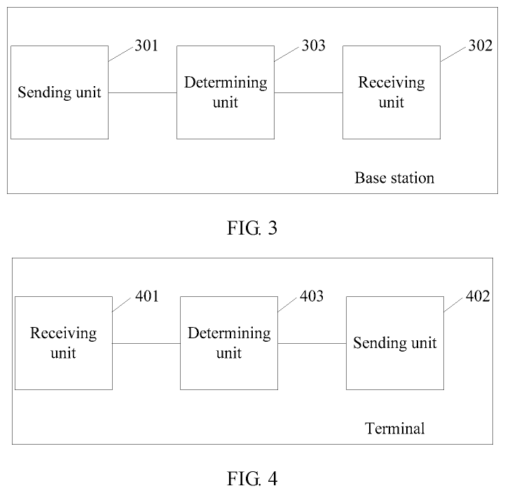

FIG. 3 is a possible schematic structural diagram of a base station configured to perform the method in the embodiment in FIG. 2. The base station includes a sending unit 301 and a receiving unit 302. The base station may further include a determining unit 303.

The sending unit 301 is configured to send uplink scheduling information to a terminal in a time cell n, where the uplink scheduling information is used to schedule a physical uplink shared channel of a time cell n+k1. The uplink scheduling information is further used to obtain a maximum quantity of first downlink data packets sent by the sending unit 301 to the terminal from a time cell n−k3 to a time cell n+k2, where n is a non-negative integer, k1, k2, and k3 are all positive integers, and k2<k1 or k2=k1. The time cell and the uplink scheduling information are the same as those in Embodiment 2. Details are not described herein again.

The receiving unit 302 is configured to receive acknowledgement information of the first downlink data packet from the terminal on the physical uplink shared channel of the time cell n+k1 based on the maximum quantity of the first downlink data packets.

The first downlink data packets include a second downlink data packet sent by the sending unit 301 to the terminal from the time cell n−k3 to a time cell n and a third downlink data packet allowed to be sent by the sending unit 301 to the terminal from the time cell n+1 to the time cell n+k2. Definitions of k2 and k3 are the same as those in the embodiment in FIG. 2. Details are not described herein again.

The second downlink data packet is a data packet sent by the base station to the terminal from the time cell n−k3 to the time cell n. Therefore, the base station may obtain a specific quantity of the second downlink data packets in the time cell n. The third downlink data packet is a data packet sent by the base station to the terminal from the time cell n+1 to the time cell n+k2. A specific quantity of the third downlink data packets may be obtained in the time cell n in which the base station sends the uplink scheduling information, or may not be obtained.

When the determining unit 303 may obtain, in the time cell n, the specific quantity of the third downlink data packets to be sent by the base station to the terminal from the time cell n+1 to the time cell n+k2, the sending unit 301 may notify the terminal of the specific quantity of the second downlink data packets and the specific quantity of the third downlink data packets by using the uplink scheduling information, or may notify the terminal of a sum of the specific quantity of the second downlink data packets and the specific quantity of the third downlink data packets by using the uplink scheduling information.

When the determining unit 303 fails to obtain, in the time cell n, the specific quantity of the third downlink data packets to be sent by the base station to the terminal from the time cell n+1 to the time cell n+k2, the determining unit 303 fails to obtain, in the time cell n, a specific quantity of the third downlink data packets to be sent by the base station to the terminal behind the time cell n. In this case, the base station performs one of the following four operations.

First, the uplink scheduling information sent by the sending unit 301 includes first indication information and second indication information, the first indication information is used to indicate a quantity of the second downlink data packets, and the second indication information is used to indicate a maximum quantity of the third downlink data packets. The base station fails to know the specific quantity of the third downlink data packets and fails to notify the terminal of the specific quantity of the third downlink data packets. Therefore, the base station may notify the terminal of the maximum quantity of the third downlink data packets by using the uplink scheduling information. In other words, no matter how many downlink data packets are sent by the sending unit 301 to the terminal from the time cell n+1 to the time cell n+k2, the terminal feeds back, based only on the maximum quantity of the third downlink data packets, acknowledgement information of the downlink data packets received by the terminal from the time cell n+1 to the time cell n+k2. The terminal feeds back the acknowledgement information of the downlink data packets received by the terminal from the time cell n−k3 to the time cell n+k2 to the base station based on the quantity of the second downlink data packets and the maximum quantity of the third downlink data packets.

Second, the uplink scheduling information sent by the sending unit 301 includes first indication information, the first indication information is used to indicate a quantity of the second downlink data packets, and a maximum quantity of the third downlink data packets is predefined or configured by using higher layer signaling of the base station. The base station or the terminal fails to know the specific quantity of the third downlink data packets and fails to notify the terminal of the specific quantity of the third downlink data packets. However, the maximum quantity of the third downlink data packets may be predefined by a protocol, or the maximum quantity of the third downlink data packets may be configured by using the higher layer signaling of the base station. Therefore, the base station or the terminal may obtain the maximum quantity of the third downlink data packets sent by the sending unit 301 to the terminal from the time cell n+1 to the time cell n+k2. In other words, no matter how many downlink data packets are sent by the sending unit 301 to the terminal from the time cell n+1 to the time cell n+k2, the terminal feeds back, based only on the maximum quantity of the third downlink data packets, acknowledgement information of the downlink data packets received by the terminal from the time cell n+1 to the time cell n+k2. The terminal feeds back the acknowledgement information of the downlink data packets received by the terminal from the time cell n−k3 to the time cell n+k2 to the base station based on the quantity of the second downlink data packets and the maximum quantity of the third downlink data packets.

Third, the uplink scheduling information sent by the sending unit 301 includes first indication information, the first indication information is used to indicate a quantity Q2 of the second downlink data packets, and the maximum quantity of the first downlink data packets is min(k2′, (Q3−Q2))+Q2. In other words, the determining unit 303 of the base station or the terminal determines min(k2′, (Q3−Q2))+Q2 as the maximum quantity of the first downlink data packets, where k2′ is a quantity of time cells allowed to transmit a downlink data packet from the time cell n+1 to the time cell n+k2, in other words, k2′ is a quantity of remaining time cells different from a time cell that cannot be used to transmit a downlink data packet from the time cell n+1 to the time cell n+k2, and the time cell that cannot be used to transmit the downlink data packet may be, for example, an uplink subframe or a reserved subframe; and k2′+k3′≤Q3, k3′ is a quantity of time cells allowed to transmit a downlink data packet from the time cell n−k3 to the time cell n, in other words, k3′ is a quantity of remaining time cells different from a time cell that cannot be used to transmit a downlink data packet from the time cell n−k3 to the time cell n, the time cell that cannot be used to transmit the downlink data packet may be, for example, an uplink subframe or a reserved subframe, Q3 is the maximum quantity of hybrid automatic repeat request processes that is supported by the terminal device, and both Q2 and Q3 are positive integers. The base station or the terminal fails to know the specific quantity of the third downlink data packets and fails to notify the terminal of the specific quantity of the third downlink data packets. However, the sending unit 301 may notify the terminal of the quantity of the second downlink data packets by using the uplink scheduling information, the determining unit 303 of the base station or the terminal determines a minimum value between k2′ and a value that is obtained by subtracting the quantity of the second downlink data packets from the maximum quantity of hybrid automatic repeat request processes that is supported by the terminal device, and uses a sum of the minimum value and the quantity of the second downlink data packets as the maximum quantity of the first downlink data packets. In other words, no matter how many downlink data packets are sent by the sending unit 301 to the terminal from the time cell n−k3 to the time cell n+k2, the terminal feeds back, based only on the maximum quantity of the first downlink data packets, acknowledgement information of the downlink data packets received by the terminal from the base station from the time cell n−k3 to the time cell n+k2.

For example, the quantity Q2 of the second downlink data packets is 2, and the maximum quantity Q3 of hybrid automatic repeat request processes that is supported by the terminal is 6. In other words, the terminal can buffer only at most six downlink data packets. If there are seven time cells in total from the time cell n+1 to the time cell n+k2, but two of the time cells are uplink subframes that cannot be used to transmit the downlink data packet, k2′ is 5 and min(5, (6−2))=4. Therefore, the maximum quantity of the first downlink data packets is 4+2=6, in other words, the maximum quantity of the first downlink data packets is the maximum quantity Q3 of hybrid automatic repeat request processes that is supported by the terminal device. If there are seven time cells in total from the time cell n+1 to the time cell n+k2, but four of the time cells are uplink subframes that cannot be used to transmit the downlink data packet, k2′ is 3 and min(3, (6−2))=3. Therefore, the maximum quantity of the first downlink data packets is 3+2=5, in other words, although the terminal is still capable of continuing to buffer the downlink data packet, due to a limitation of k2, the terminal can store three downlink data packets as the third downlink data packet only after the sending unit 301 of the base station sends the uplink scheduling information, where k2 is predefined, or k2 is indicated by the uplink scheduling information, or k2 is semi-statically configured by using higher layer signaling of the network device, or k2 is determined based on a minimum hybrid automatic repeat request feedback timing capability supported by the terminal device. The minimum hybrid automatic repeat request feedback timing capability supported by the terminal device is a shortest time period t from a time point at which the terminal device receives the downlink data packet to a time point at which the terminal device sends acknowledgement information of the first downlink data packet, and t is a minimum value of (k1−k2), in other words, a minimum quantity of time cells required by the terminal to generate the acknowledgement information.

Fourth, the uplink scheduling information sent by the sending unit 301 includes third indication information, and the third indication information is used to indicate the maximum quantity of the first downlink data packets. The base station fails to know the specific quantity of the third downlink data packets and fails to notify the terminal of the specific quantity of the third downlink data packets. However, the sending unit 301 may notify the terminal of a maximum value of a sum of the quantity of the second downlink data packets and the quantity of the third downlink data packets by using the uplink scheduling information. In other words, no matter how many downlink data packets are sent by the sending unit 301 to the terminal from the time cell n−k3 to the time cell n+k2, the terminal feeds back, based only on the maximum quantity of the first downlink data packets, acknowledgement information of the downlink data packets received by the terminal from the base station from the time cell n−k3 to the time cell n+k2.

In the first to the third manners, although the base station fails to know, in the time cell n, the specific quantity of the third downlink data packets to be sent by the base station to the terminal from the time cell n+1 to the time cell n+k2, the base station and the terminal may obtain the maximum quantity of the first downlink data packets by using an actual quantity of the second downlink data packets and a maximum quantity of the third downlink data packets. In the fourth manner, the base station directly indicates the maximum quantity of the first downlink data packets of the terminal by using the third indication information.

The first indication information, the second indication information, or the third indication information includes a downlink assignment indicator, and the DAI is a part of fields in the UL grant.

The maximum quantity of the first downlink data packets is Q1, the acknowledgement information includes Q1 groups of acknowledgement information, and Q1 is a positive integer. The acknowledgement information of the downlink data packet may be fed back in a unit of a CBG, or the acknowledgement information of the downlink data packet may be fed back in a unit of a transport block TB. If the base station configures the terminal to perform the feedback in a unit of a CBG from the time cell n−k3 to the time cell n+k2, a feedback of all data packets including data packets received in the time cell n+1 and the third downlink data packet is rolled back to a feedback performed by the terminal in a unit of a TB. In other words, the acknowledgement information of the third downlink data packet is generated in a unit of a transport block TB. Therefore, signaling overheads of the acknowledgement information can be reduced.

When the third downlink data packet is sent by the sending unit to the terminal in a plurality of carriers, acknowledgement information of the third downlink data packet in the plurality of carriers is combined by the determining unit 303 to generate the acknowledgement information of the third downlink data packet in a logic AND manner. When the third downlink data packet includes a plurality of codewords, acknowledgement information of the plurality of codewords is combined by the determining unit 303 to generate the acknowledgement information of the third downlink data packet in the logic AND manner.

The sending unit 301 may be a transmitter or a transceiver, the receiving unit 302 may be a receiver or a transceiver, and the determining unit 303 may be a processor. In addition, the base station may further include a memory connected to the processor. The memory is configured to store program code, an instruction, or data, and the processor is configured to execute the code or the instruction stored in the memory.

A chip is provided, configured to perform the steps performed by the base station in the embodiment in FIG. 2. The chip may have a part of functions of a memory, a processor, a transmitter, a receiver, and/or a transceiver, and the memory stores an instruction, code, and/or data, to enable the chip to perform the steps performed by the base station in the embodiment in FIG. 2.

In this embodiment, the base station receives the acknowledgement information of the first downlink data packet from the terminal on the PUSCH of the time cell n+k1 based on the maximum quantity of the first downlink data packets. The terminal sends the acknowledgement information of the first downlink data packet to the base station on the PUSCH of the time cell n+k1 based on the maximum quantity of the first downlink data packets. The base station and the terminal reach consensus on a quantity of pieces of acknowledgement information fed back by the terminal to the base station on the PUSCH of the time cell n+k1. Therefore, when the acknowledgement information is sent on the PUSCH, a data reception error caused by a case in which the base station does not know, when decoding the data, a quantity of pieces of acknowledgement information actually sent by the terminal is avoided.

FIG. 4 is a possible schematic structural diagram of a terminal configured to perform the method in the embodiment in FIG. 2. The terminal includes a receiving unit 401 and a sending unit 402. The terminal may further include a generation unit 403.

The receiving unit 401 is configured to receive uplink scheduling information from a base station in a time cell n, where the uplink scheduling information is used to schedule a physical uplink shared channel of a time cell n+k1, the uplink scheduling information is further used to obtain a maximum quantity of first downlink data packets sent by the base station to the terminal device from a time cell n−k3 to a time cell n+k2, where n is a non-negative integer, k1, k2, and k3 are all positive integers, and k2<k1 or k2=k1. The time cell and the uplink scheduling information are the same as those in Embodiment 2. Details are not described herein again.

The sending unit 402 is configured to send acknowledgement information of the first downlink data packet to the base station on the physical uplink shared channel of the time cell n+k1 based on the maximum quantity of the first downlink data packets.

The first downlink data packets include a second downlink data packet sent by the base station to the terminal device from the time cell n−k3 to a time cell n and a third downlink data packet allowed to be sent by the base station to the terminal device from the time cell n+1 to the time cell n+k2. Definitions of k2 and k3 are the same as those in the embodiment in FIG. 2. Details are not described herein again.

The second downlink data packet is a data packet sent by the base station to the terminal from the time cell n−k3 to the time cell n. Therefore, the base station may obtain a specific quantity of the second downlink data packets in the time cell n. The third downlink data packet is a data packet sent by the base station to the terminal from the time cell n+1 to the time cell n+k2. A specific quantity of the third downlink data packets may be obtained in the time cell n in which the base station sends the uplink scheduling information, or may not be obtained.

When the base station may obtain, in the time cell n, the specific quantity of the third downlink data packets to be sent by the base station to the terminal from the time cell n+1 to the time cell n+k2, the base station may notify the terminal of the specific quantity of the second downlink data packets and the specific quantity of the third downlink data packets by using the uplink scheduling information, or may notify the terminal of a sum of the specific quantity of the second downlink data packets and the specific quantity of the third downlink data packets by using the uplink scheduling information.

When the base station fails to obtain, in the time cell n, the specific quantity of the third downlink data packets to be sent by the base station to the terminal from the time cell n+1 to the time cell n+k2, the base station fails to obtain, in the time cell n, a specific quantity of the third downlink data packets to be sent by the base station to the terminal behind the time cell n. In this case, the terminal performs one of the following four operations.

First, the uplink scheduling information includes first indication information and second indication information, the first indication information is used to indicate a quantity of the second downlink data packets, and the second indication information is used to indicate a maximum quantity of the third downlink data packets. The base station fails to know a specific quantity of the third downlink data packets and fails to notify the terminal of the specific quantity of the third downlink data packets. Therefore, the base station may notify the terminal of the maximum quantity of the third downlink data packets by using the uplink scheduling information, and the receiving unit 401 of the terminal may receive the uplink scheduling information and obtain the maximum quantity of the third downlink data packets In other words, no matter how many downlink data packets are sent by the base station to the terminal from the time cell n+1 to the time cell n+k2, the terminal feeds back, based only on the maximum quantity of the third downlink data packets, acknowledgement information of the downlink data packets received by the terminal from the time cell n+1 to the time cell n+k2. The sending unit 402 feeds back the acknowledgement information of the downlink data packets received by the terminal from the time cell n−k3 to the time cell n+k2 to the base station based on the quantity of the second downlink data packets and the maximum quantity of the third downlink data packets.

Second, the uplink scheduling information includes first indication information, the first indication information is used to indicate a quantity of the second downlink data packets, and a maximum quantity of the third downlink data packets is predefined or configured by using higher layer signaling of the base station. The terminal fails to know the specific quantity of the third downlink data packets and fails to notify the terminal of the specific quantity of the third downlink data packets. However, the maximum quantity of the third downlink data packets may be predefined by a protocol, or the maximum quantity of the third downlink data packets may be configured by using the higher layer signaling of the base station. Therefore, the base station may obtain the maximum quantity of the third downlink data packets from the time cell n+1 to the time cell n+k2. In other words, no matter how many downlink data packets are sent by the base station to the terminal from the time cell n+1 to the time cell n+k2, the terminal feeds back, based only on the maximum quantity of the third downlink data packets, acknowledgement information of the downlink data packets received by the terminal from the time cell n+1 to the time cell n+k2. The sending unit 402 feeds back the acknowledgement information of the downlink data packets received by the terminal from the time cell n−k3 to the time cell n+k2 to the base station based on the quantity of the second downlink data packets and the maximum quantity of the third downlink data packets.

Third, the uplink scheduling information includes first indication information, the first indication information is used to indicate a quantity Q2 of the second downlink data packets, and the maximum quantity of the first downlink data packets is min(k2′, (Q3−Q2))+Q2. In other words, the terminal determines min(k2′, (Q3−Q2))+Q2 as the maximum quantity of the first downlink data packets, where k2′ is a quantity of time cells allowed to transmit a downlink data packet from the time cell n+1 to the time cell n+k2, in other words, k2′ is a quantity of remaining time cells different from a time cell that cannot be used to transmit a downlink data packet from the time cell n+1 to the time cell n+k2, and the time cell that cannot be used to transmit the downlink data packet may be, for example, an uplink subframe or a reserved subframe; and k2′+k3′≤Q3, k3′ is a quantity of time cells allowed to transmit a downlink data packet from the time cell n−k3 to the time cell n, in other words, k3′ is a quantity of remaining time cells different from a time cell that cannot be used to transmit the downlink data packet from the time cell n−k3 to the time cell n, the time cell that cannot be used to transmit the downlink data packet may be, for example, an uplink subframe or a reserved subframe, Q3 is a maximum quantity of hybrid automatic repeat request processes that is supported by the terminal device, and both Q2 and Q3 are positive integers. The base station or the terminal fails to know the specific quantity of the third downlink data packets and fails to notify the terminal of the specific quantity of the third downlink data packets. However, the base station notifies the terminal of the quantity of the second downlink data packets by using the uplink scheduling information, and the generation unit 403 of the terminal determines a minimum value between k2′ and a value that is obtained by subtracting the quantity of the second downlink data packets from the maximum quantity of hybrid automatic repeat request processes that is supported by the terminal device, and uses a sum of the minimum value and the quantity of the second downlink data packets as the maximum quantity of the first downlink data packets. In other words, no matter how many downlink data packets are sent by the base station to the terminal from the time cell n−k3 to the time cell n+k2, the sending unit 402 feeds back, based only on the maximum quantity of the first downlink data packets, acknowledgement information of the downlink data packets received by the terminal from the base station from the time cell n−k3 to the time cell n+k2.

For example, the quantity Q2 of the second downlink data packets is 2, and the maximum quantity Q3 of hybrid automatic repeat request processes that is supported by the terminal is 6. In other words, the terminal can buffer only at most six downlink data packets. If there are seven time cells in total from the time cell n+1 to the time cell n+k2, but two of the time cells are uplink subframes that cannot be used to transmit the downlink data packet, k2′ is 5 and min(5, (6−2))=4. Therefore, the maximum quantity of the first downlink data packets is 4+2=6, in other words, the maximum quantity of the first downlink data packets is the maximum quantity Q3 of hybrid automatic repeat request processes that is supported by the terminal device. If there are seven time cells in total from the time cell n+1 to the time cell n+k2, but four of the time cells are uplink subframes that cannot be used to transmit the downlink data packet, k2′ is 3 and min(3, (6−2))=3. Therefore, the maximum quantity of the first downlink data packets is 3+2=5, in other words, although the terminal is still capable of continuing to buffer the downlink data packet, due to a limitation of k2, the terminal can store three downlink data packets as the third downlink data packet only after the base station sends the uplink scheduling information, where k2 is predefined, or k2 is indicated by the uplink scheduling information, or k2 is semi-statically configured by using higher layer signaling of the network device, or k2 is determined based on a minimum hybrid automatic repeat request feedback timing capability supported by the terminal device. The minimum hybrid automatic repeat request feedback timing capability supported by the terminal device is a shortest time period t from a time point at which the terminal device receives the downlink data packet to a time point at which the terminal device sends acknowledgement information of the first downlink data packet, and t is a minimum value of (k1−k2), in other words, a minimum quantity of time cells required by the generation unit 403 to generate the acknowledgement information.

Fourth, the uplink scheduling information includes third indication information, and the third indication information is used to indicate the maximum quantity of the first downlink data packets. The base station fails to know the specific quantity of the third downlink data packets and fails to notify the terminal of the specific quantity of the third downlink data packets. However, the base station may notify the terminal of a maximum value of a sum of the quantity of the second downlink data packets and the quantity of the third downlink data packets by using the uplink scheduling information. In other words, no matter how many downlink data packets are sent by the base station to the terminal from the time cell n−k3 to the time cell n+k2, the sending unit 402 feeds back, based only on the maximum quantity of the first downlink data packets, acknowledgement information of the downlink data packets received by the terminal from the base station from the time cell n−k3 to the time cell n+k2.

The first indication information, the second indication information, or the third indication information includes a downlink assignment indicator (Downlink Assignment Indicator, DAI), and the DAI is a part of fields in the UL grant.

The generation unit 403 is configured to begin to generate the acknowledgement information of the first downlink data packet in the time cell n+k2.

The maximum quantity of the first downlink data packets is Q1, the acknowledgement information includes Q1 groups of acknowledgement information, and Q1 is a positive integer. The acknowledgement information of the downlink data packet may be fed back in a unit of a CBG, or the acknowledgement information of the downlink data packet may be fed back in a unit of a transport block TB. If the base station configures the terminal to perform the feedback in a unit of a CBG from the time cell n−k3 to the time cell n+k2, a feedback of all data packets including data packets in the time cell n+1 and the third downlink data packet is rolled back to a feedback performed by the terminal in a unit of a TB. In other words, the acknowledgement information of the third downlink data packet is generated in a unit of a transport block TB. Therefore, signaling overheads of the acknowledgement information can be reduced.

When the third downlink data packet is sent by the sending unit to the terminal in a plurality of carriers, acknowledgement information of the third downlink data packet in the plurality of carriers is combined by the generation unit 403 to generate the acknowledgement information of the third downlink data packet in a logic AND manner. When the third downlink data packet includes a plurality of codewords, acknowledgement information of the plurality of codewords is combined by the generation unit 403 to generate the acknowledgement information of the third downlink data packet in the logic AND manner.

The receiving unit 401 may be a receiver or a transceiver, the sending unit 402 may be a transmitter or a transceiver, and the generation unit 403 may be a determining unit or a processor. In addition, the terminal may further include a memory connected to the processor. The memory is configured to store program code, an instruction, or data, and the processor is configured to execute the code or the instruction stored in the memory.

A chip is provided, configured to perform the steps performed by the terminal in the embodiment in FIG. 2. The chip may have a part of functions of a memory, a processor, a transmitter, a receiver, and/or a transceiver, and the memory stores an instruction, code, and/or data, to enable the chip to perform the steps performed by the terminal in the embodiment in FIG. 2.

In this embodiment, the base station receives the acknowledgement information of the first downlink data packet from the terminal on the PUSCH of the time cell n+k1 based on the maximum quantity of the first downlink data packets. The terminal sends the acknowledgement information of the first downlink data packet to the base station on the PUSCH of the time cell n+k1 based on the maximum quantity of the first downlink data packets. The base station and the terminal reach consensus on a quantity of pieces of acknowledgement information fed back by the terminal to the base station on the PUSCH of the time cell n+k1. Therefore, when the acknowledgement information is sent on the PUSCH, a data reception error caused by a case in which the base station does not know, when decoding the data, a quantity of pieces of acknowledgement information actually sent by the terminal is avoided.

In the several embodiments provided in accordance with this disclosure, it should be understood that the disclosed system, apparatus, and method may be implemented in other manners. For example, the described apparatus embodiment is merely an example. For example, the unit division is merely logical function division. There may be another division manner during actual implementation. For example, a plurality of units or components may be combined or integrated into another system, or some features may be ignored or may not be performed. In addition, the displayed or discussed mutual couplings or direct couplings or communication connections may be implemented by using some interfaces. The indirect couplings or communication connections between the apparatuses or units may be implemented in electrical, mechanical, or another form.

The units described as separate parts may or may not be physically separate. Parts displayed as units may or may not be physical units, and may be located in one position, or may be distributed on a plurality of network units. Some or all of the units may be selected based on an actual requirement to achieve the objectives of the solutions of the embodiments.

In addition, functional units in the embodiments may be integrated into one processing unit, or each of the units may exist alone physically, or two or more units may be integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of this application essentially, or the part contributing to the prior art, or all or some of the technical solutions may be implemented in the form of a software product. The computer software product is stored in a storage medium and includes several instructions for instructing a computer device (which may be a personal computer, a server, or a network device) to perform all or some of the steps of the methods described in the embodiments. The storage medium includes various media that can store program code, such as a USB flash drive, a removable hard disk, a read-only memory (ROM, Read-Only Memory), a random access memory (RAM, Random Access Memory), a magnetic disk, or an optical disc.

What is claimed is:

1. An acknowledgement information sending method, comprising:
receiving, by a terminal device, uplink scheduling information from a network device in a time cell n, wherein the uplink scheduling information is configured to schedule a physical uplink shared channel of a time cell n+k1, the uplink scheduling information is further configured to obtain a maximum quantity of first downlink data packets sent by the network device to the terminal device from a time cell n−k3 to a time cell n+k2, wherein n is a non-negative integer, k1, k2, and k3 are all positive integers, and k2<k1 or k2=k1; and
sending, by the terminal device, acknowledgement information of the first downlink data packet to the network device on the physical uplink shared channel of the time cell n+k1 based on the maximum quantity of the first downlink data packets.

2. The method according to claim 1, wherein
the first downlink data packets comprise a second downlink data packet sent by the network device to the terminal device from the time cell n−k3 to a time cell n and a third downlink data packet allowed to be sent by the network device to the terminal device from the time cell n+1 to the time cell n+k2, wherein
the uplink scheduling information comprises first indication information and second indication information, the first indication information is configureed to indicate a quantity of the second downlink data packets, and the second indication information is configured to indicate a maximum quantity of the third downlink data packets; or
the uplink scheduling information comprises first indication information, the first indication information is configured to indicate a quantity of the second downlink data packets, and a maximum quantity of the third downlink data packets is predefined or configured by using higher layer signaling of the network device; or
the uplink scheduling information comprises first indication information, the first indication information is configured to indicate a quantity Q2 of the second downlink data packets, and the maximum quantity of the first downlink data packets is min(k2′, (Q3−Q2))+Q2, wherein k2′ is a quantity of time cells allowed to transmit a downlink data packet from the time cell n+1 to the time cell n+k2, Q3 is a maximum quantity of hybrid automatic repeat request processes that is supported by the terminal device, Q2 is a non-negative integer, and Q3 is a positive integer.

3. The method according to claim 2, wherein
the third downlink data packet is received by the terminal device from the network device in a plurality of carriers, and acknowledgement information of the third downlink data packet in the plurality of carriers is combined to generate the acknowledgement information of the third downlink data packet in a logic AND manner.

4. The method according to claim 1, wherein
the uplink scheduling information comprises third indication information, and the third indication information is configured to indicate the maximum quantity of the first downlink data packets.

5. The method according to claim 4, wherein
the first indication information, the second indication information, or the third indication information comprises a downlink assignment indicator (DAD.

6. The method according to claim 1, wherein k2′+k3′≤Q3, and k3′ is a quantity of time cells allowed to transmit a downlink data packet from the time cell n−k3 to the time cell n, wherein Q3 is a maximum quantity of hybrid automatic repeat request processes that is supported by the terminal device.

7. The method according to claim 1, wherein
the minimum hybrid automatic repeat request feedback timing capability supported by the terminal device is a shortest time period t from a time point at which the terminal device receives the downlink data packet to a time point at which the terminal device sends the acknowledgement information of the first downlink data packet, and t is a minimum value of (k1−k2).

8. The method according to claim 1, wherein the method further comprises:
beginning to generate, by the terminal device, the acknowledgement information of the first downlink data packet in the time cell n+k2.

9. A terminal device, comprising:
a receiving unit, configured to receive uplink scheduling information from a network device in a time cell n, wherein the uplink scheduling information is configured to schedule a physical uplink shared channel of a time cell n+k1, the uplink scheduling information is further configured to obtain a maximum quantity of first downlink data packets sent by the network device to the terminal device from a time cell n−k3 to a time cell n+k2, wherein n is a non-negative integer, k1, k2, and k3 are all positive integers, and k2<k1 or k2=k1; and
a sending unit, configured to send acknowledgement information of the first downlink data packet to the network device on the physical uplink shared channel of the time cell n+k1 based on the maximum quantity of the first downlink data packets.

10. The terminal device according to claim 9, wherein
the first downlink data packets comprise a second downlink data packet sent by the network device to the terminal device from the time cell n−k3 to a time cell n and a third downlink data packet allowed to be sent by the network device to the terminal device from the time cell n+1 to the time cell n+k2, wherein
the uplink scheduling information comprises first indication information and second indication information, the first indication information is configured to indicate a quantity of the second downlink data packets, and the second indication information is configured to indicate a maximum quantity of the third downlink data packets; or
the uplink scheduling information comprises first indication information, the first indication information is configured to indicate a quantity of the second downlink data packets, and a maximum quantity of the third downlink data packets is predefined or configured by using higher layer signaling of the network device; or
the uplink scheduling information comprises first indication information, the first indication information is configured to indicate a quantity Q2 of the second downlink data packets, and the maximum quantity of the first downlink data packets is min(k2′, (Q3−Q2))+Q2, wherein k2′ is a quantity of time cells allowed to transmit a downlink data packet from the time cell n+1 to the time cell n+k2, Q3 is a maximum quantity of hybrid automatic repeat request processes that is supported by the terminal device, Q2 is a non-negative integer, and Q3 is a positive integer.

11. The terminal device according to claim 10, wherein
the uplink scheduling information comprises third indication information, and the third indication information is configured to indicate the maximum quantity of the first downlink data packets.

12. The terminal device according to claim 11, wherein
the first indication information, the second indication information, or the third indication information comprises a downlink assignment indicator (DAT).

13. The terminal device according to claim 9, wherein k2′+k3′≤Q3, and k3′ is a quantity of time cells allowed to transmit a downlink data packet from the time cell n−k3 to the time cell n, wherein Q3 is a maximum quantity of hybrid automatic repeat request processes that is supported by the terminal device.

14. The terminal device according to claim 9, wherein
the minimum hybrid automatic repeat request feedback timing capability supported by the terminal device is a shortest time period t from a time point at which the receiving unit receives the downlink data packet to a time point at which the sending unit sends the acknowledgement information of the first downlink data packet, and t is a minimum value of (k1−k2).

15. The terminal device according to claim 9, wherein the terminal device further comprises:
a generation unit, configured to begin to generate the acknowledgement information of the first downlink data packet in the time cell n+k2.

16. The terminal device according to claim 15, wherein
the third downlink data packet is received by the receiving unit from the network device in a plurality of carriers, and acknowledgement information of the third downlink data packet in the plurality of carriers is combined by the generation unit to generate the acknowledgement information of the third downlink data packet in a logic AND manner.

17. An acknowledgement information receiving method, comprising:
sending, by a network device, uplink scheduling information to a terminal device in a time cell n, wherein the uplink scheduling information is configured to schedule a physical uplink shared channel of a time cell n+k1, the uplink scheduling information is further configured to obtain a maximum quantity of first downlink data packets sent by the network device to the terminal device from a time cell n−k3 to a time cell n+k2, wherein n is a non-negative integer, k1, k2, and k3 are all positive integers, and k2<k1 or k2=k1; and
receiving, by the network device, acknowledgement information of the first downlink data packet from the terminal device on the physical uplink shared channel of the time cell n+k1 based on the maximum quantity of the first downlink data packets.

18. The acknowledgement information receiving method according to claim 17, wherein the first downlink data packets comprise a second downlink data packet sent by the network device to the terminal device from the time cell n−k3 to a time cell n and a third downlink data packet allowed to be sent by the network device to the terminal device from the time cell n+1 to the time cell n+k2, wherein
the uplink scheduling information comprises first indication information and second indication information, the first indication information is configured to indicate a quantity of the second downlink data packets, and the second indication information is configured to indicate a maximum quantity of the third downlink data packets; or
the uplink scheduling information comprises first indication information, the first indication information is configured to indicate a quantity of the second downlink data packets, and a maximum quantity of the third downlink data packets is predefined or configured by using higher layer signaling of the network device; or
the uplink scheduling information comprises first indication information, the first indication information is configured to indicate a quantity Q2 of the second downlink data packets, and the maximum quantity of the first downlink data packets is min(k2′, (Q3−Q2))+Q2, wherein k2′ is a quantity of time cells allowed to transmit a downlink data packet from the time cell n+1 to the time cell n+k2, Q3 is a maximum quantity of hybrid automatic repeat request processes that is supported by the terminal device, Q2 is a non-negative integer, and Q3 is a positive integer.

19. The acknowledgement information receiving method according to claim 17, wherein the uplink scheduling information comprises third indication information, and the third indication information is configured to indicate the maximum quantity of the first downlink data packets.

20. The acknowledgement information receiving method according to claim 17, wherein k2′+k3′≤Q3, and k3′ is a quantity of time cells allowed to transmit a downlink data packet from the time cell n−k3 to the time cell n, wherein Q3 is a maximum quantity of hybrid automatic repeat request processes that is supported by the terminal device.
